(19) United States
(12) Patent Application Publication
(10) Pub. No.: US 2010/0121526 A1
(43) Pub. Date: May 13, 2010

(54) Speed warning method and apparatus for navigation system

(76) Inventor: Don Pham, Torrance, CA (US)

Correspondence Address: MURAMATSU & ASSOCIATES, Suite 310, 114 Pacifica, Irvine, CA, 92618, US

(21) Appl. No.: 12/291,562

(22) Filed: Nov. 12, 2008

(51) Int. Cl. G06F 19/00; B60Q 1/00

(52) U.S. Cl. 701/36; 340/441

(57) ABSTRACT

A method and apparatus allows the driver to set a threshold speed for generating a warning by slightly modifying the speed limit, such that a warning mechanism can be activated when the vehicle speed exceeds the threshold speed. The method and apparatus achieves a convenient interface for the driver to set the threshold speeds at once according to different speed limits by setting a number such as a percentage in a speed adjustment unit. The number indicates the difference in percentage between the speed limit and the threshold speed. The threshold speed can be either higher or lower than the speed limit based on the driving style and preference of the driver.

### FIELD OF THE INVENTION

This invention relates to a speed limit warning apparatus and method, and more specifically, to a speed limit warning apparatus and method to be implemented in combination with a navigation system for achieving a convenient interface for the driver to set a threshold speed for generating a warning regarding the speed limit depending upon particular locations where a vehicle is running.

### BACKGROUND OF THE INVENTION

Safety is always the most important concern in vehicle driving, and speeding is one of the common causes of traffic accidents. Since high speed usually reduces the possibility to respond in time for drivers, accidents are more likely to occur at higher speed. Speeding not only threatens the lives of the driver and passenger in a vehicle, but also the lives of people in other vehicles and pedestrians nearby.

In order to avoid speeding and remind drivers of the maximum speed allowed by law, the government sets different speed limits in different kinds of roads, times or areas. However, drivers sometimes fail to drive under speed limit because they either do not know the speed limit in certain areas, or do not pay attention to it. A proper speed limit notice is thus needed for drivers to not only avoid a speeding citation but also unnecessary car accidents due to the speeding.

To provide speed limit information to drivers, most navigation systems include the function of speed limit notice. For example, U.S. Pat. No. 6,845,317 issued to Craine discloses a navigation-based speed limit recording and warning system to allow a driver to selectively input and record the posted speed limits. Even though this conventional technology provides a speed limit recording and warning system, the driver has to take his/her own action to record the speed limit information along the route to enable the warning system. If there are several different speed limits along the route, it may be dangerous to take the driver's eyes out of the road because the driver has to pay attention to different speed limits and record them into the navigation system.

U.S. Pat. No. 6,778,074 issued to Cuozzo discloses a speed limit indicator for determining and displaying a speed limit, which makes it easy for the driver to compare the current speed with the legal limit for the location in which he is traveling. However, this conventional technology does not allow the driver to slightly modify the speed limit along the route. For example, if the driver would like to drive slower, he or she may want to customize the speed limit ten percent below the legal limit, which is not possible by the conventional technology.

U.S. Pat. No. 6,515,596 issued to Awada discloses an apparatus for reporting a posted speed limit to the driver, comparing the actual speed of the vehicle with the posted speed limit and issuing a warning to the driver when the actual speed exceeds the posted speed. However, similar to the '074 to Cuozzo noted above, this conventional technology does not allow the driver to slightly modify the speed limit along the route.

For example, a driver of old age may want to drive a car even slower than a posted speed limit-while a young driver may want to drive a car slightly faster than a posted speed limit which may be within an acceptable error range of speedometers. Therefore, there remains a need for a new and improved speed limit warning apparatus and method implemented in combination with a navigation system which enables the driver to slightly modify the speed limit according to the driver's driving style and preference.

### SUMMARY OF THE INVENTION

It is, therefore, an object of the present invention to provide a speed warning method and apparatus to be implemented in combination with a navigation system for achieving a convenient interface for the driver to set a threshold speed for generating a warning regarding the speed limit depending upon a particular location where a vehicle is running.

Namely, the present invention relates to a method and an apparatus for providing a warning regarding a vehicle speed to a driver when the vehicle speed exceeds the threshold speed. More specifically, the present invention allows the driver to set the threshold level for generating a warning regarding the vehicle speed which is slightly higher or lower than the posted speed limit based on the user's driving style and preference. For example, if the user likes to drive slowly, the warning threshold of the vehicle speed can be set even lower than the posted speed limit. On the other hand, the driver can also set the warning threshold of the vehicle speed higher than the speed limit, for example, within an acceptable error range of speedometer. In the latter case, however, the driver should pay attention to the speeding enforcement tolerance to avoid traffic citations and penalties.

The present invention is especially advantageous when the driver travels to several different areas with different speed limits. The present invention provides a simple and convenient interface for the driver not only to receive speed limit information along the route, but also to set different threshold levels of the vehicle speed for producing the warning according to different speed limits at once. Thus, the driver does not have to modify the threshold speed for generating the warning repeatedly when encountering different speed limits. Since the driver only has to set the threshold speed for generating the warning once, the “driver distraction” during the driving can be significantly reduced or minimized and the driver can be much more focused on operating the vehicle.

In one embodiment, the speed warning indication apparatus comprises a navigation system, a vehicle speed display unit (VSDU) and a connecting element. The navigation system may include a map database, a speed adjustment unit, a warning mechanism and a control unit. Once the destination is set, the navigation system, e.g. a global positioning system (GPS), determines the current position of the vehicle and determines a route to the destination.

The navigation system retrieves from the map database different speed limits in different areas along the route, thereby reporting the speed limits to the driver. The driver can then determine different threshold speeds for issuing a warning at once corresponding to the different speed limits along the route. For example, by setting a number in the speed adjustment unit which indicates a difference in percentage between the posted speed limit and the vehicle speed, the threshold speed for generating the warning can be set for each speed limit.

Once the threshold speed, for example, a percentage in the difference between the posted speed limit and the vehicle speed, for generating the warning is determined, the navigation system compares the threshold speed and the current vehicle speed. The current vehicle speed can be obtained from the speed sensor and displayed on the vehicle speed display unit via the connecting element. If the vehicle speed exceeds the threshold speed selected by the driver, a warning mechanism is activated to generate the warning, typically by voice sound to remind the driver that the vehicle speed is too high.

The threshold speed for generating the warning set by the driver can be lower or higher than the legal speed limit based on the driver's driving style and preference. In one aspect, if the user attempts to set the threshold speed for the warning is higher than the posted speed limit, the control unit is activated to control the number in the speed adjustment unit to prevent the driver from overly speeding. In another aspect, instead of controlling the number, a warning sign or voice instruction may be generated if the threshold speed set by the user is, for example, more than ten percent of the posted speed limit. On the other hand, if the speed threshold level set by the user is far lower than the posted speed limit, the control unit can also be triggered to suggest the driver to increase the speed level to expedite the traffic flow.

The present invention together with the above and other advantages may best be understood from the following detailed descriptions of the embodiments of the invention made with reference to the drawings below.

### BRIEF DESCRIPTION OF THE DRAWINGS

FIG. 1 is a schematic diagram showing a conventional warning speed indication system in which the driver has to set the warning speed repeatedly.

FIG. 2 is a schematic diagrams showing a concept of one embodiment of the speed warning indication apparatus disclosed in the present invention in which the threshold speed for generating the warning is lower than the legal speed limit, and different threshold speeds are set at once according to different speed limits.

FIG. 3 is a schematic diagram showing the embodiment as that of FIG. 2 in which the warning mechanism may be activated if the vehicle speed exceeds the threshold speed along the route.

FIG. 4 is a schematic diagrams showing a concept of another embodiment of the speed warning indication apparatus disclosed in the present invention in which the threshold speed for generating the warning is higher than the legal speed limit, and different threshold speeds are set at once according to different speed limits.

FIG. 5 is a schematic diagram showing the embodiment as that of FIG. 4 in which the warning mechanism may be activated if the vehicle speed exceeds the threshold speed along the route.

FIG. 6 is a flow chart illustrating procedural steps for conducting a method of providing speed limit information and setting the threshold speed for generating the warning in accordance with the present invention.

FIG. 7 is a functional block diagram showing an example of structure of a vehicle navigation system implementing the speed warning indication method and apparatus of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the present invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

This present invention relates to a speed warning indication apparatus and method to be implemented in combination with a navigation system. More specifically, the present invention not only provides the speed limit information to the driver, but also allows the driver to set his or her own threshold speed for generating a warning which may be above or below the legal speed limit. Furthermore, if the driver travels through several different areas having different speed limits, the present invention provides a simple and convenient interface for the driver to easily and quickly set different threshold speeds for generating warning according to the different speed limits.

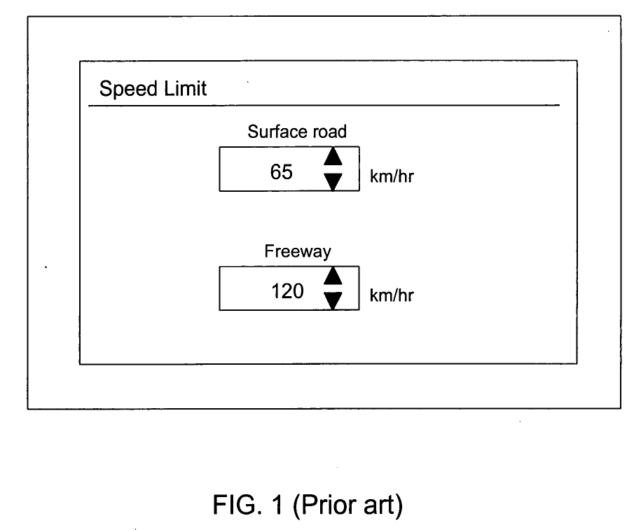

FIG. 1 is a schematic diagram showing a conventional warning speed indication system in which the driver is able to set the threshold speed according to the driver's driving style and preference, so that the threshold speed for the warning can be higher or lower than the posted speed limit. However, there arises a situation where different areas along the route may have different speed limits. For example, as can be seen in FIG. 1, the threshold speed for the warning is set by the driver on a surface road, and the driver has to set the warning speed again when entering a freeway.

In the example of FIG. 1, if the driver has to travel through a school zone thereafter, he or she may have to set the threshold speed again in response to the lower speed limit. Setting the threshold speed repeatedly for different speed limits is time-consuming and inconvenient for the driver especially when he or she is driving. Moreover, since the driver is distracted from operating the vehicle when changing such a threshold level of the vehicle speed, a car accident might result.

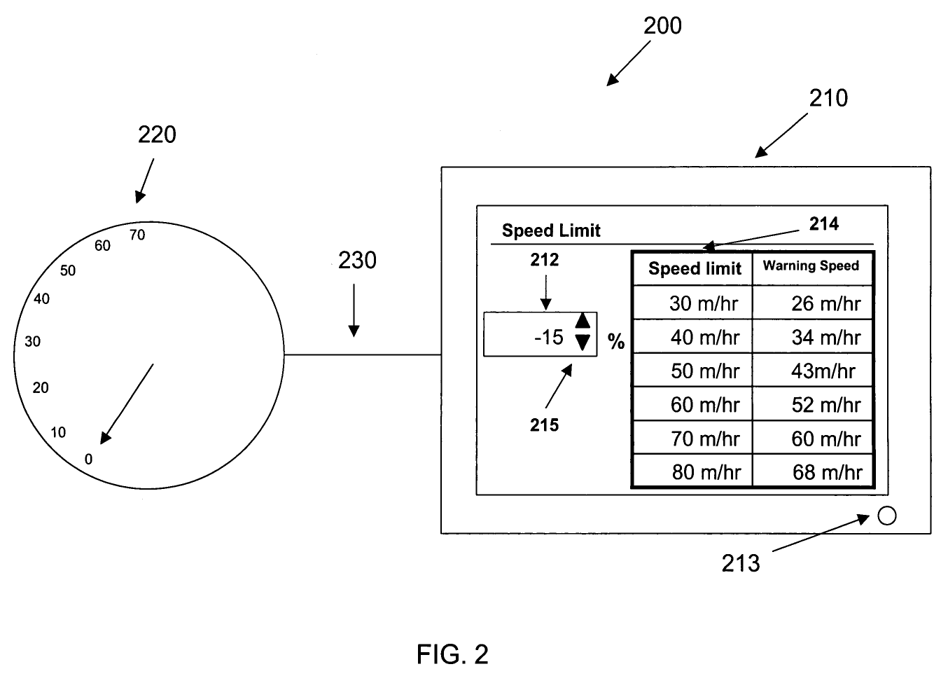

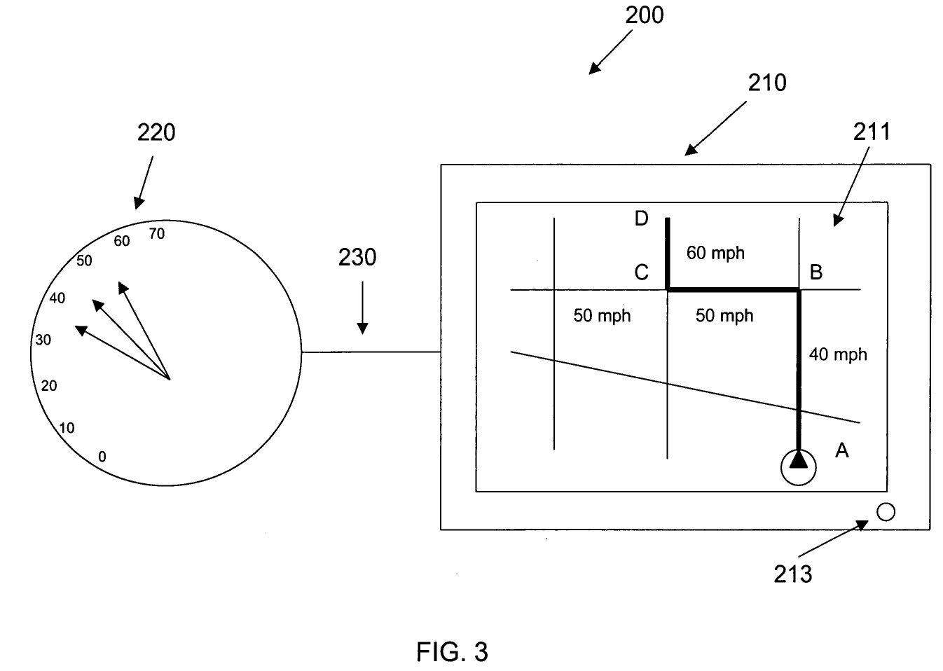

According to one embodiment of the present invention illustrated in FIGS. 2 and 3, a speed warning indication system 200 comprises a navigation system 210, a vehicle speed display unit (VSDU) 220, and a connecting element 230. The navigation system 210 includes a map 211, a speed adjustment unit 212, a warning mechanism 213, a speed information table 214 and a control unit 215. After the destination is set, the navigation system 210 calculates a preferable route and retrieves speed limit information along the route to the destination.

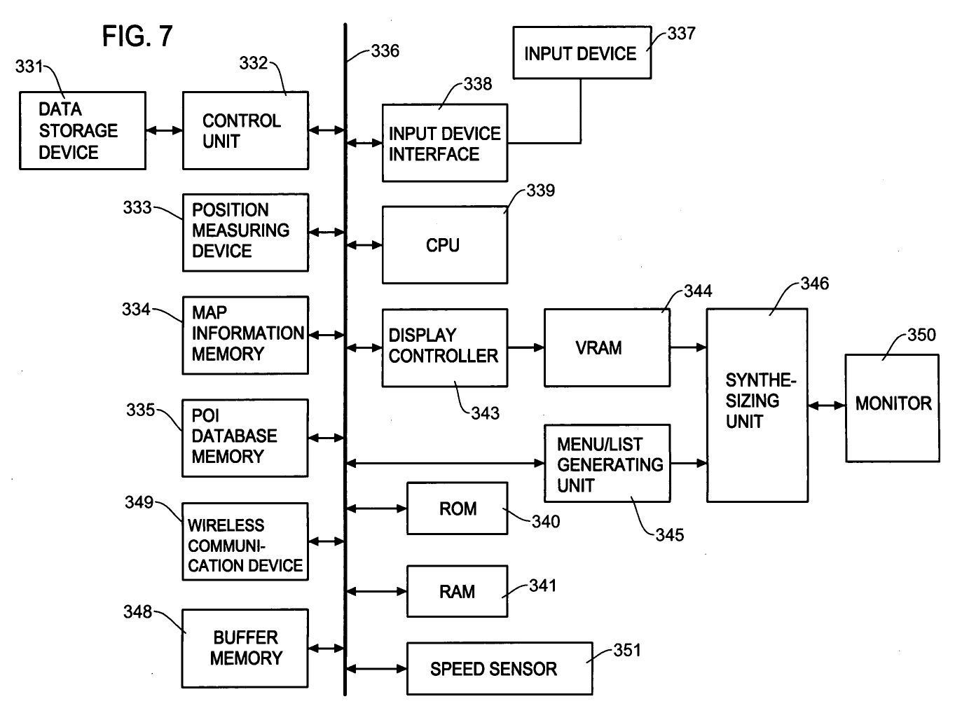

In the example of FIG. 2, the speed limit information is displayed on the left hand side of the speed information table 214. Such speed limit information can be obtained from a remote database via a wireless communication or the map database (ex. data storage device 331 in FIG. 7) of the navigation system 210. Based on the driver's driving style and preference, the present invention allows the driver to set a threshold speed (warning speed) for generating a warning, which can be higher or lower than the speed limit. If the vehicle speed exceeds the threshold speed set by the driver, the warning mechanism 213, for example, a warning light and/or a warning by voice sound is activated accordingly.

Referring to FIG. 2, the threshold speed for generating the warning is determined by a number set by the driver in the speed adjustment unit 212. In this example, the number indicates a percentage value of the difference between the threshold speed for the warning and the legal speed limit. Once the number (ex. percentage value) is decided, different threshold speeds (warning speeds) are determined at once at right hand side of the speed information table 214 according to the different speed limits on the route.

For example, if the driver would like to set the threshold speed which is fifteen percent lower (negative value) than the posted speed limit, different threshold speeds (warning speeds) are shown at once on the information table 214 corresponding to the different speed limits along the route. This interface provides a simple and convenient interface for the driver to set the threshold speed and saves the driver's time without repeating the threshold speed setting process according to different speed limits. More importantly, the present invention can significantly reduce the driver's distraction from the safe driving by setting two or more different threshold speeds at once.

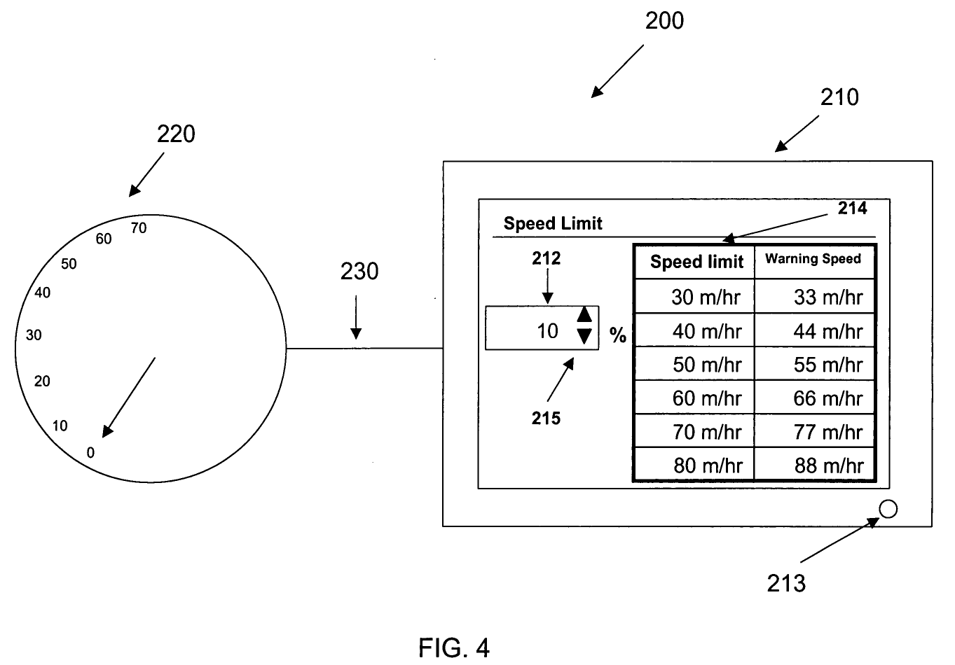

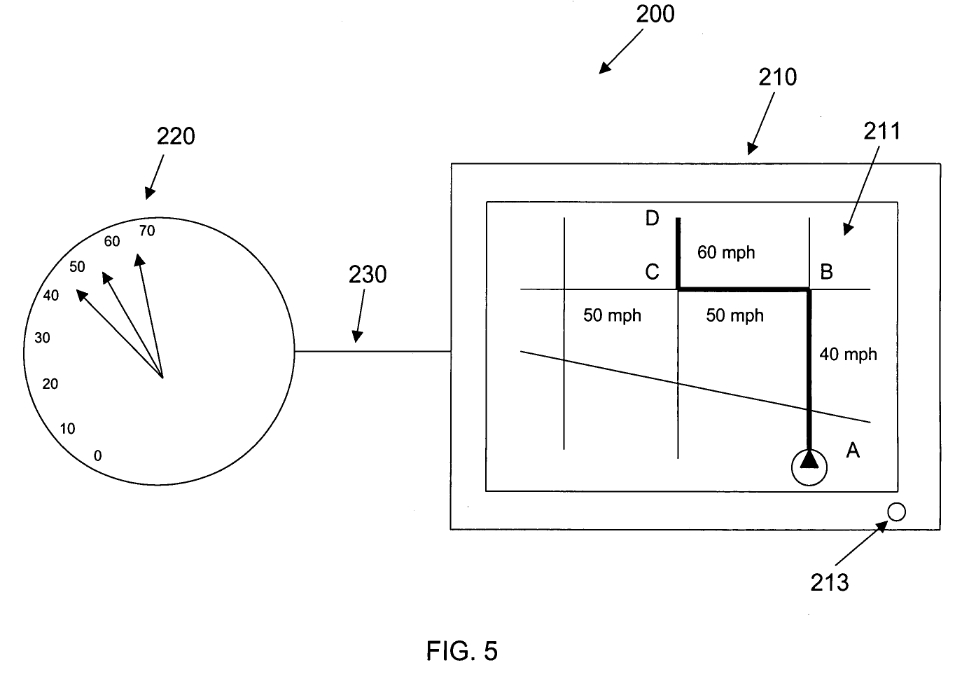

Likewise, FIGS. 4 and 5 illustrate another embodiment of the present invention where the driver would like to drive faster than the posted speed limit. For example, the threshold speed is set ten percent higher (positive value) than the legal speed limit. In order to prevent the driver from setting the threshold speed too higher than the legal speed limit, the control unit 215 is activated. The control unit 215 can be a part of central processor of the navigation system such as a CPU 339 in FIG. 7 which controls the overall operation of the navigation system.

In one aspect, the control unit 215 can prevent the driver from setting the threshold speed too higher such as more than ten percent of the speed limit. This can be done by limiting the maximum percentage value, generating a warning sign or voice instruction if the threshold speed set by the user is, for example, more than ten percent of the posted speed limit. In another aspect, the control unit 215 may allow the driver to set the warning speed a little more than ten percent of the speed limit, however, a warning sign and/or a voice notice may be generated to remind the driver of the speeding issue.

Even though “driving slowly” is usually recommended, driving too slowly may adversely affect the normal traffic flow on the roadway. Thus, in one embodiment, the control unit 215 may prevent the driver from setting the threshold speed too lower than the speed limit, for example, thirty percent lower than the speed limit. This can be done by limiting the maximum percentage value with a negative sign (minus) or generating a warning sign or voice instruction if the threshold speed set by the user is too low.

The vehicle speed display unit (VSDU) 220 can be, but not limited to, a normal speedometer or a light-emitting diode (LED) display of a vehicle. The connecting element 230 is adapted to transmit the vehicle speed information from the VSDU 220 to the navigation system 210, such that the navigation system 210 can compare the vehicle speed with the threshold speed for warning. Alternatively, the navigation system 210 may include by itself a speed sensor (ex., speed sensor 351 in FIG. 7) to detect the vehicle current speed to compare with the threshold speed. The warning mechanism 213 is activated when the vehicle speed exceeds the threshold speed, thereby generating the warning.

Referring to the example of FIG. 3, the driver travels from a point A to a point D on the map 211 where the speed limits in different areas are 40 mph (A to B), 50 mph (B to C) and 60 mph (C to D), respectively. The speed limit information along the route is provided by either remote database or the database inside the navigation system 210. As illustrated above, different threshold speeds according to different speed limits can be set at once in the speed information table 214, by the number set in the speed adjustment unit 212.

As can be seen from FIGS. 2 and 3, for example, if the driver would like to set the threshold speed fifteen percent below the legal speed limit, the threshold speeds along the route (from point A to point D) are 34 mph (from point A to point B), 43 mph (from point B to point C) and 52 mph (from point C to point D), respectively. Thus, if the vehicle speed exceeds 34 mph while traveling from point A to point B, the warning mechanism 213 is triggered to remind the driver of reducing the speed. Likewise, if the vehicle speed exceeds 43 mph from point B to point C, or exceeds 52 mph from point C to point D, the warning mechanism 213 would also be activated to provide warning signals or messages to the driver to reduce the speed.

Referring to FIGS. 4 and 5, the driver sets the threshold speed (warning speed) which is ten percent higher than the legal speed limit. In FIG. 5, applying the higher warning speed in the same map 211 and the same route (from point A to point D) as shown in FIG. 3, the threshold speeds along the route (from point A to point D) are 44 mph (from point A to point B), 55 mph (from point B to point C) and 66 mph (from point C to point D), respectively. Thus, the warning mechanism 213 is triggered when the vehicle speed exceeds 44 mph (A to B), 55 mph (B to C), or 66 mph (C to D), respectively.

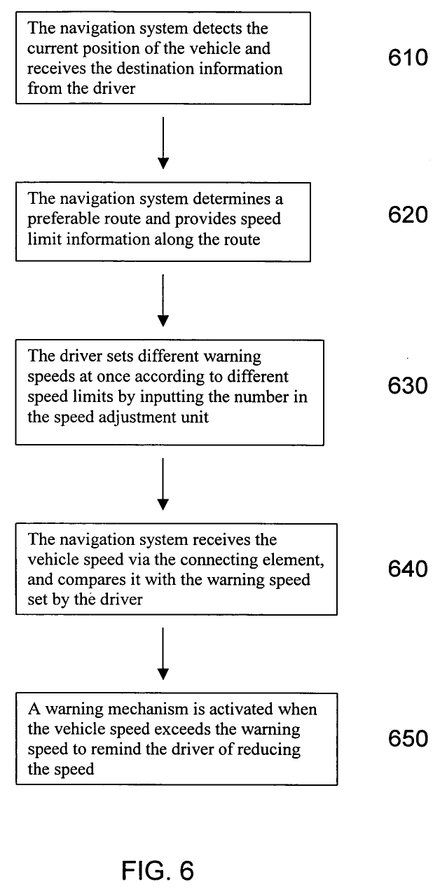

A method of providing speed limit information to a driver is illustrated in a flow chart of FIG. 6. In step 610, the navigation system 210, for example, a global positioning system (GPS) is adapted to detect the current position of the vehicle and determine a preferable route once the driver inputs the destination information. Also, the navigation system retrieves the speed limit information along the route and displays them in step 620.

According to step 630, the number is determined and input in the speed adjustment unit 212, which indicates a difference in percentage between the legal speed limit and a threshold speed for generating a warning. The threshold speed can be higher or lower than the speed limit based on the driver's driving style. Accordingly, different threshold speeds are determined at once corresponding to different speed limits along the route because the user has set the percentage of the difference in the speeds. In one embodiment, the control unit is adapted to prevent the driver from overly speeding. For example, the control unit 215 may prevent the driver from setting the number higher than 10% in the speed adjustment unit 212.

In steps 640 and 650, once the threshold speed (warning speed) is determined, the navigation system 210 compares the threshold speed and the vehicle speed received from the VSDU 220 through the connecting element 230. In one embodiment, the vehicle speed display unit 220 and the navigation system 210 can be both connected to a CAN (Controller Area Network) system, such that the vehicle speed information can be transmitted from the vehicle display unit 220 to the navigation system 210 through the CAN system. If the vehicle speed exceeds the threshold speed, the warning mechanism 213 is activated to generate the warning thereby reminding the driver to reduce the vehicle speed.

FIG. 7 is a block diagram showing an example of structure of a vehicle navigation system for implementing the present invention. In the block diagram, the navigation system includes a data storage device 331 such as a hard disc, CD-ROM, DVD or other storage means for storing the map data. The navigation system includes a control unit 332 for controlling an operation for reading the information from the data storage device 331, and a position measuring device 333 for measuring the present vehicle position or user position. For example, the position measuring device 333 has a vehicle speed sensor for detecting a moving distance, a gyroscope for detecting a moving direction, a microprocessor for calculating a position, a GPS (global positioning system) receiver for receiving GPS signals from satellites for calculating a current position, and etc.

The block diagram of FIG. 7 further includes a map information memory 334 for storing the map information which is read from data storage device 331, a database memory 335 for storing database information such as point of interest (POI) information which is read out from the data storage device 231, a remote controller 337 for executing a menu selection operation, an enlarge/reduce operation, a destination input operation, etc. and a remote controller interface 338. Although a remote controller is a typical example for selecting menus, executing selected functions and etc., the navigation system includes various other input methods to achieve the same and similar operations done through the remote controller.

In FIG. 7, the navigation system further includes a bus 336 for interfacing the above units in the system, a processor (CPU) 339 for controlling an overall operation of the navigation system, a ROM 340 for storing various control programs such as a route search program and a map matching program necessary for navigation control, a RAM 341 for storing a processing result such as a guide route, a display controller 343 for generating map image (a map guide image and an arrow guide image) on the basis of the map information, a VRAM 344 for storing images generated by the display controller 343, a menu/list generating unit 345 for generating menu image/various list images, a synthesizing unit 346, a data transceiver 349 for wireless communication to retrieve data from a remote server, a buffer memory 348 for temporally storing data for ease of data processing, a monitor (display) 350, and a speed sensor 351.

A program for conducting the operation of the speed warning indication in the present invention shown in the flow chart of FIG. 6 is stored in the ROM 340 or other memory and is executed by the CPU 339. The CPU 339 controls an overall operation of the navigation system including the speed warning indication method and apparatus of the present invention. The speed sensor 351 detects the current speed of the vehicle and sends the detected speed to the CPU 139 which compares the threshold speed. The threshold speeds set by the driver may be stored in a local memory such as the buffer memory 348 or a memory in the CPU 339 so that the CPU 339 utilizes causes to generate the warning when the current speed exceeds the threshold speed.

As has been described above, according to the present invention, the speed warning apparatus and method is implemented in combination with the navigation system to allow the driver to set a threshold speed for generating a warning regarding the speed limit depending upon particular locations where a vehicle is running. The present invention allows the driver to set the threshold level which is slightly higher or lower than the speed limit based on the user's driving style and preference. The present invention is especially advantageous when the driver travels in several different areas with different speed limits. The present invention provides a simple and convenient interface for the driver not only to receive speed limit information along the route, but also to set different threshold levels of the vehicle speed for producing the warning according to different speed limits at once.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A speed warning apparatus incorporated with a navigation system for generating a warning when a vehicle speed exceeds a threshold speed, comprising:
a vehicle speed display unit;
a navigation system having a speed adjustment unit, a warning mechanism and a database providing speed limit information; and
a connecting element transmitting vehicle speed information from the vehicle speed display unit to the navigation system,
wherein different threshold speeds are determined at once according to different speed limits along a route by inputting a number in the speed adjustment unit, which indicates a difference in percentage between each speed limit and the threshold speed.

2. The speed warning apparatus as defined in claim 1, wherein the navigation system further comprises a speed information table on which different threshold speeds are listed according to different speed limits along the route, and a control unit adapted to control the number in the speed adjustment unit.

3. The speed warning apparatus as defined in claim 1, wherein the warning mechanism is activated when the vehicle speed exceeds the threshold speed set by a driver.

4. The speed warning apparatus as defined in claim 2, wherein the number in said speed adjustment unit is positive.

5. The speed warning apparatus as defined in-claim 2, wherein the number in said speed adjustment unit is negative.

6. The speed warning apparatus as defined in claim 2, wherein the control unit prevents a driver from inputting the number in the speed adjustment unit which is beyond a predetermined range set by the control unit.

7. The speed warning apparatus as defined in claim 4, wherein a warning signal for speeding is generated when the number set in said speed adjustment unit is beyond a predetermined range set by the control unit.

8. An apparatus for determining a threshold speed for generating a warning according to various speed limits along a route, comprising:
a global positioning system to determine a route based on a current position and a destination;
a database providing different speed limits along the route;
a speed adjustment unit adapted to determine a threshold speed;
a control unit adapted to control the number in the speed adjustment unit; and
a speed information table including the different speed limits along the route and different threshold speeds corresponding to the different speed limits,
wherein said threshold speeds are determined by a number set in the speed adjustment unit which indicates a difference in percentage between the speed limit and the threshold speed, and once the number is decided, different threshold speeds corresponding to the different speed limits along the route are determined automatically.

9. The apparatus as defined in claim 8, wherein said apparatus is connected to a vehicle display unit through a connecting element which transmits vehicle speed information to the apparatus to compare a vehicle speed and the threshold speed, and a warning mechanism is activated when the vehicle speed exceeds the threshold speed.

10. The apparatus as defined in claim 8, wherein the number set in the speed adjustment unit is positive.

11. The apparatus as defined in claim 8, wherein the number set in the speed adjustment unit is negative.

12. The apparatus of claim 10, wherein the control unit prevents a driver from inputting the number in the speed adjustment unit which is beyond a predetermined range set by the control unit.

13. The apparatus of claim 10, wherein a warning signal for speeding is generated when the number set in said speed adjustment unit is beyond a predetermined range set by the control unit.

14. A method for providing speed information to a driver and determining a threshold speed for generating a warning, comprising the steps of:
determining a route;
providing and displaying speed limit information along the route on a speed information table;
determining different threshold speeds at once according to different speed limits along the route by inputting a number in a speed adjustment unit which indicates the difference in percentage between the speed limit and the threshold speed;
comparing the threshold speed and vehicle speed; and
activating a warning mechanism when the vehicle speed exceeds the threshold speed.

15. The method as defined in claim 14, wherein the step of determining a route comprises a step of retrieving vehicle position from a global positioning system and receiving destination information from the driver.

16. The method as defined in claim 14, wherein different threshold speeds according to different speed limits are displayed on the speed information table once the number in the speed adjustment unit is decided.

17. The method as defined in claim 14, wherein said vehicle speed is obtained from a vehicle speed display unit through a connecting element.

18. The method as defined in claim 14, wherein said number in the speed adjustment unit is positive.

19. The method as defined in claim 14, wherein said number in the speed adjustment unit is negative.

20. The method as defined in claim 18, wherein a control unit prevents the driver from inputting the number in the speed adjustment unit which is beyond a predetermined range set by the control unit.
